(19) United States
(12) Patent Application Publication
(10) Pub. No.: US 2007/0204045 A1
(43) Pub. Date: Aug. 30, 2007

(54) Printer management server, printer, and printer management system

(75) Inventor: Toshihiro Shima, Nagano-ken (JP)

Correspondence Address: SUGHRUE MION, PLLC, 2100 PENNSYLVANIA AVENUE, N.W., SUITE 800, WASHINGTON, DC, 20037, US

(73) Assignee: SEIKO EPSON CORPORATION

(21) Appl. No.: 11/188,106

(22) Filed: Jul. 25, 2005

(30) Foreign Application Priority Data
Jul. 27, 2004 (JP) 2004-218488

(51) Int. Cl. G06F 15/173

(52) U.S. Cl. 709/226

(57) ABSTRACT

In a printer management system of the invention, multiple printers are connected via a network to a management server, which performs exchange of setting information inherent to each of the multiple printers. Each of the multiple printers sends management information representing at least part of a service status of the printer. The management server acquires the management information sent from each printer and selects at least two exchange object printers to exchange their pieces of the setting information among the multiple printers, based on the acquired management information. The printer management system of the invention selects the exchange object printers according to their use frequencies shown by the management information. The locations of the selected exchange object printers are exchanged. This arrangement desirably equalizes the use frequencies of the respective printers and reduces the demand for replacement of various long-term parts in the respective printers.

### BACKGROUND OF THE INVENTION

1. Field of the Invention

The present invention relates to a technique of exchanging multiple printers connected to a network.

2. Description of the Related Art

A printing system including multiple printers and a management server linked to one identical network has become used widely in various enterprises and organizations. In the printing system, each of multiple users operates a computer (client PC) to use a preset printer for printing. In the printing system, the multiple printers may be leased by a leasing company. In such cases, the lasing company should replace a photosensitive drum, a waste toner box, and other parts requiring replacement at relatively long-term intervals (hereafter referred to as ‘long-term parts’) included in each of the multiple printers when the long-term parts reach their application limits. One significant issue is to reduce the demand for replacement of such long-term parts. Among the multiple printers, some printers have higher use frequencies and other printers have lower frequencies according to their installation sites and other conditions. The printers having higher use frequencies naturally require frequent replacement of the long-term parts. Equalization of the use frequencies of the respective printers desirably prevents such frequent replacement of the long-term parts only in some of the multiple printers and thereby reduces the total demand for replacement of the long-term parts in the multiple printers included in the printing system. One technique of equalizing the use frequencies of the respective printers is disclosed in Japanese Patent Laid-Open Gazette No. 2003-73312. The proposed technique occasionally changes the printers used as the printing destinations in the printing system to equalize the numbers of print pages by the multiple printers, that is, the use frequencies of the respective printers.

The proposed technique of the cited reference undesirably changes the printer used by each user for printing and thereby sacrifices the user's convenience. Another disadvantage of this technique is requirement for changing the settings in many client PCs (that is, settings in printers as printing destinations). Such change of the client settings significantly consumes the time and the labor.

In order to prevent frequent replacement of a certain long-term part, one possible measure exchanges the certain long-term part between the printers. The exchange of the certain long-term part between the printers, however, requires rather complicated work and is undesirably labor- and time-consuming.

### SUMMARY OF THE INVENTION

The object of the invention is thus to eliminate the drawbacks of the prior art techniques and to provide a technique adoptable to a printing system to readily reduce the demand for replacement of long-term parts without sacrificing the user's convenience.

In order to attain at least part of the above and the other related objects, the present invention is directed to a printer management system where multiple printers are linked via a network to a management server, which performs exchange of setting information inherent to each of the multiple printers.

Each of the multiple printers has a transmitting/receiving execution module that sends management information representing at least part of a service status of the printer to the management server.

The management server has an exchange process execution module that acquires the management information sent from the each printer and selects at least two exchange object printers to exchange their pieces of the setting information among the multiple printers, based on the acquired management information.

The printer management system of the invention selects the exchange object printers according to their use frequencies shown by the management information. The locations of the selected exchange object printers are exchanged. This arrangement desirably equalizes the use frequencies of the respective printers and reduces the demand for replacement of various long-term parts in the respective printers.

In one preferable embodiment of the printer management system of the invention, each of the multiple printers further includes a setting information reflection module.

The exchange process execution module of the management server sends the setting information of each exchange object printer as new setting information to each partner exchange object printer.

The transmitting/receiving execution module of each exchange object printer acquires the new setting information sent from the management server. The setting information reflection module of the each exchange object printer enables reflection of the acquired new setting information, in place of the setting information originally set in the each exchange object printer, at a preset timing.

The setting information of the partner exchange object printer is accordingly reflected in each exchange object printer, in place of the original setting information of the exchange object printer. Even after the location exchange between each exchange object printer and the partner exchange object printer, the user originally using the partner exchange object printer can use the replaced exchange object printer without any inconvenience.

In one preferable application of the printer management system of this embodiment, the exchange process execution module of the management server sends a transmission request of the setting information to each exchange object printer.

The transmitting/receiving execution module of the each exchange object printer receives the transmission request from the management server and sends back the setting information to the management server.

The exchange process execution module of the management server acquires the setting information sent back from the each exchange object printer.

The management server can thus readily acquire the setting information of each exchange object printer.

In the printer management system of the invention, the setting information may include at least communication information for identifying each exchange object printer on the network.

Even after the location exchange between each exchange object printer and the partner exchange object printer, the user originally using the partner exchange object printer can use the replaced exchange object printer without any inconvenience.

In another preferable application of the printer management system of the above embodiment, in response to successful reception of the new setting information, the transmitting/receiving execution module of each exchange object printer notifies the management server of successful reception.

The exchange process execution module of the management server is notified of successful reception of the new setting information by each exchange object printer. In response to the notification of successful reception, the exchange process execution module notifies each exchange object printer of successful transmission of the setting information of the each exchange object printer to each partner exchange object printer.

The transmitting/receiving execution module of each exchange object printer is notified of successful transmission of the setting information of the each exchange object printer to each partner exchange object printer by the management server. In response to the notification of successful transmission, the setting information reflection module of the each exchange object printer enables reflection of the acquired new setting information, in place of the setting information originally set in the each exchange object printer, at the preset timing.

Each exchange object printer enables reflection of the acquired new setting information, in place of the original setting information, after the successful transmission of the setting information of the exchange object printer to the partner exchange object printer. This arrangement effectively prevents duplicated setting of the identical setting information (for example, the communication information) in plural exchanged object printers.

In another preferable embodiment of the printer management system of the invention, the exchange process execution module of the management server sends location information representing a location of each exchange object printer to each partner exchange object printer and makes the each partner exchange object printer output the location information.

This arrangement enables any dispatched worker to readily exchange the location of each exchange object printer with the location of each partner exchange object printer, based on the output location information.

In the printer management system of the invention, the multiple printers may be supported by an identical printer driver.

In the case of the location exchange between each exchange object printer and the partner exchange object printer, this arrangement desirably reduces the user's operations required to change the settings in a computer that is used to give a print command to each exchange object printer.

At least part of the objects of the invention is attained by a management server that is linked with multiple printers via a network and performs exchange of setting information inherent to each of the multiple printers.

The management server includes: an exchange process execution module that acquires management information, which represents at least part of a service status of each printer and is sent from the each printer, and selects at least two exchange object printers to exchange their pieces of the setting information among the multiple printers, based on the acquired management information.

The management server of the invention selects the exchange object printers according to their use frequencies shown by the management information. The locations of the selected exchange object printers are exchanged. This arrangement desirably equalizes the use frequencies of the respective printers and reduces the demand for replacement of various long-term parts in the respective printers.

In one preferable embodiment of the management server of the invention, the exchange process execution module sends the setting information of each exchange object printer as new setting information to each partner exchange object printer.

The setting information of the partner exchange object printer is accordingly reflected in each exchange object printer, in place of the original setting information of the exchange object printer. Even after the location exchange between each exchange object printer and the partner exchange object printer, the user originally using the partner exchange object printer can use the replaced exchange object printer without any inconvenience.

In one preferable application of the management server of this embodiment, the exchange process execution module sends a transmission request of the setting information to each exchange object printer, and acquires the setting information sent back from the each exchange object printer.

The management server can thus readily acquire the setting information of each exchange object printer.

In the management server of the invention, the setting information may include at least communication information for identifying each exchange object printer on the network.

Even after the location exchange between each exchange object printer and the partner exchange object printer, the user originally using the partner exchange object printer can use the replaced exchange object printer without any inconvenience.

In another preferable application of the management server of the above embodiment, the exchange process execution module is notified of successful reception of the new setting information by each exchange object printer. In response to the notification of successful reception, the exchange process execution module notifies each exchange object printer of successful transmission of the setting information of the each exchange object printer to each partner exchange object printer.

Each exchange object printer enables reflection of the acquired new setting information, in place of the original setting information, after the successful transmission of the setting information of the exchange object printer to the partner exchange object printer. This arrangement effectively prevents duplicated setting of the identical setting information (for example, the communication information) in plural exchanged object printers.

In another preferable embodiment of management server of the invention, the exchange process execution module sends location information representing a location of each exchange object printer to each partner exchange object printer and makes the each partner exchange object printer output the location information.

This arrangement enables any dispatched worker to readily exchange the location of each exchange object printer with the location of each partner exchange object printer, based on the output location information.

At least part of the objects of the invention is also attained by a printer that is linked via a network to a management server, which performs exchange of setting information inherent to each of multiple printers.

The printer sends management information representing at least part of a service status of the printer to the management server, and is specified as one of at least two exchange object printers to exchange the setting information with a partner exchange object printer, based on the transmitted management information.

The printer includes: a transmitting/receiving execution module that acquires setting information of the partner exchange object printer from the management server; and a setting information reflection module that enables reflection of the acquired setting information of the partner exchange object printer, in place of the setting information originally set in the printer, at a preset timing.

The location of the printer of this configuration is exchanged, for example, with the location of the partner exchange object printer selected to exchange the setting information. The location exchange desirably equalizes the use frequencies of this printer and the partner exchange object printer and thereby effectively reduces the demand for replacement of long-term parts in these printers.

In one preferable embodiment of the invention, the printer further includes an output module that outputs specified information.

The transmitting/receiving module acquires location information representing a location of the partner exchange object printer from the management server, and the output module outputs the acquired location information.

This arrangement enables any dispatched worker to readily exchange the location of the printer with the location of the partner exchange object printer, based on the output location information.

The technique of the invention is not restricted to the printer management system, the management server, or the printer described above, but may be applicable to a corresponding printer management method. Other possible applications of the invention include computer programs to establish the printer management system, the management server, the printer, and the printer management method, recording media in which such computer programs are recorded, and data signals that include such computer programs and are embodied in carrier waves.

In the applications of the invention as the computer programs and the recording media in which the computer programs are recorded, the invention may be given as a whole program to control the operations of the printer management system, the management server, or the printer or as a partial program to exert only the characteristic functions of the invention.

### BRIEF DESCRIPTION OF THE DRAWINGS

FIG. 1 schematically illustrates the configuration of a printer management system in one embodiment of the invention;

FIG. 2 shows the structure of a printer PRT and a management server SV included in the printer management system of the embodiment;

FIG. 3 is a flowchart showing an exchange object printer selecting process executed in the embodiment;

FIG. 4 shows a management information table used in the embodiment;

FIG. 5 is a flowchart showing a printer exchange process executed in the embodiment;

FIG. 6 is a flowchart showing the printer exchange process executed in the embodiment; and

FIGS. 7(A) and 7(B) are flowcharts showing a new setting information reflection flag set-on process executed by respective exchange object printers in the embodiment.

### DESCRIPTION OF THE PREFERRED EMBODIMENTS

One mode of carrying out the invention is described below as a preferred embodiment in the following sequence:
A. Embodiment
   A1. System Configuration
   A2. Functions of Printer and Management Server
   A3. Exchange Object Printer Selection Process
   A4. Printer Exchange Process
   A5. New Setting Information Reflection Flag Set-on Process
   A6. Effects of Embodiment
B. Modifications

### A. Embodiment

A1. System Configuration

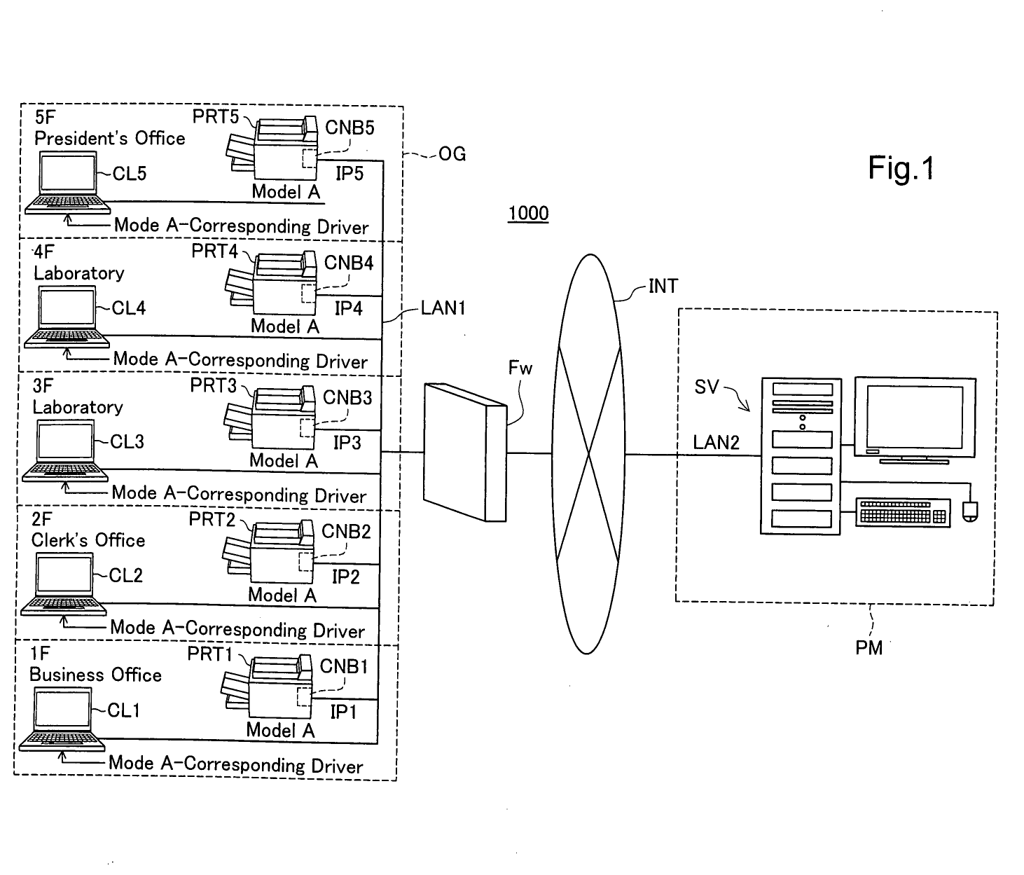

FIG. 1 schematically illustrates the configuration of a printer management system in one embodiment of the invention. The printer management system 1000 of this embodiment is established between a selected printer manager (hereafter simply referred to as the manager) PM and a selected organization (hereafter simply referred to as the organization) OG. In the printer management system 1000, personal computers PC of multiple clients (hereafter comprehensively referred to as clients CL) located in the organization OG and multiple printers PRT located in the organization OG are connected to a management server SV of the manager PM. The multiple printers PRT and the multiple clients CL are interconnected via a local area network LAN1 built in this system. The local area network LAN1 is linked to the Internet INT via a firewall FW. The management server SV is connected to a local area network LAN2, which is also linked to the Internet INT.

As shown in FIG. 1, printers PRT1 to PRT5 are installed in certain offices on respective floors, 1st floor to 5th floor, in a building of the organization OG and are connected to the local area network LAN1. Clients CL1 to CL5 are also installed in the certain offices on the respective floors and are connected to the local area network LAN1. Each of the clients CL1 to CL5 on each floor is set to send print jobs via the local area network LAN1 to the corresponding one of the printers PRT on the same floor. For example, the client CL1 sends print jobs to the printer PRT1. The printers PRT1 to PRT5 are all model A of a specific manufacturer. A printer driver corresponding to the model A is installed in the clients CL1 to CL5 to allow printing operations of the corresponding printers PRT.

Communication between the individual devices connected to the network (that is, between the respective printers PRT and the corresponding clients CL and between the respective printers PRT and the management server SV) are based on the TCP/IP protocol. Fixed IP addresses are allocated in advance to the respective devices. Communication data sent from a sender device includes specification of both an IP address of the sender device (sender IP address) and an IP address of a receiver device (receiver IP address). The communication data is sent to the receiver device having the specified receiver IP address. These IP addresses are not directly set in the clients CL, the printers PRT or the management server SV, but are set in nodes of the TCP/IP network (that is, in specified memories of network boards connected to the network for the TCP/IP communication). In this embodiment, IP addresses IP1 to IP5 are respectively allocated to the printers PRT1 to PRT5 as shown in FIG. 1.

The local area network LANI connecting with the respective printers PRT is linked to the Internet INT via the firewall FW as mentioned above. The management server SV is thus not allowed to make access to each of the printers PRT over the firewall FW. In the printer management system of the embodiment, the management server SV has the functions of a Web server and allows each printer PRT to adopt HTPPS (HyperText Transfer Protocol Security) as a type of HTTP (HyperText Transfer Protocol) and establish connection with the management server SV. On establishment of connection of each printer PRT to the management server SV, the management server SV is allowed to download preset information to the printer PRT. In this embodiment, each of the printers PRT establishes connection with the management server SV after the printer PRT sequentially performs connection authentication for an access to the management server SV and negotiation to exchange required information including the connection speed with the management server SV. Each printer PRT is allowed to upload preset information to the management server SV after establishment of the connection. Encrypted communication by the protocol HTTPS is made between each of the printers PRT and the management server SV for the raised security level. For example, identification information for unequivocal identification of the printer PRT1 by the management server SV and a password for connection authentication to the management server SV are set in advance in the printer PRT1. The printer PRT1 uses the identification information and the password to establish connection with the management server SV after the connection authentication.

The printers PRT1 to PRT5 respectively include custom network boards CNB1 to CNB5 as network interfaces (network I/F) having identical functions. Each of the custom network boards CNB included in the printers PRT1 to PRT5 receives communication data that includes a print job and is sent from one of the clients CL1 to CL5 to the corresponding one of the printers PRT1 to PRT5. Each custom network board CNB also obtains total print page number data among various pieces of management information stored in each printer PRT and notifies the management server SV of the obtained total print page number data. In the event of selection of a printer PRT including a specified custom network board CNB as an object printer to be exchanged in an exchange object printer selection process executed by the management server SV (described later), the specified custom network board CNB notifies the management server SV of diverse pieces of setting information set in the selected printer PRT and in the specified custom network board CNB in response to a request from the management server SV. The specified custom network board CNB receives the setting information of the other object printer PRT currently located in the place of an exchange destination (transfer destination) from the management server SV in a printer exchange process executed by the management server SV (described later), and replaces the original setting information of the selected printer PRT as the object printer with the received setting information of the other object printer PRT at a preset timing. These functions of the custom network boards CNB and the setting information are described later in detail.

The management server SV executes the exchange object printer selection process and the printer exchange process. In the exchange object printer selection process, the management server SV refers to the total print page number data received from the respective printers PRT and compares the frequencies in use of the respective printers PRT. The management server SV selects two printers PRT as object printers to be exchanged (hereafter referred to as ‘exchange object printers’), based on the result of the comparison. In the printer exchange process, the management server SV acquires the pieces of setting information from the two selected exchange object printers PRT, exchanges the acquired pieces of setting information, and downloads the exchanged pieces of setting information to the respective exchange object printers PRT. After the download, the management server SV gives an exchange instruction to each of the two selected exchange object printers PRT. The exchange object printer selection process and the printer exchange process are described later in detail.

A2. Functions of Printer and Management Server

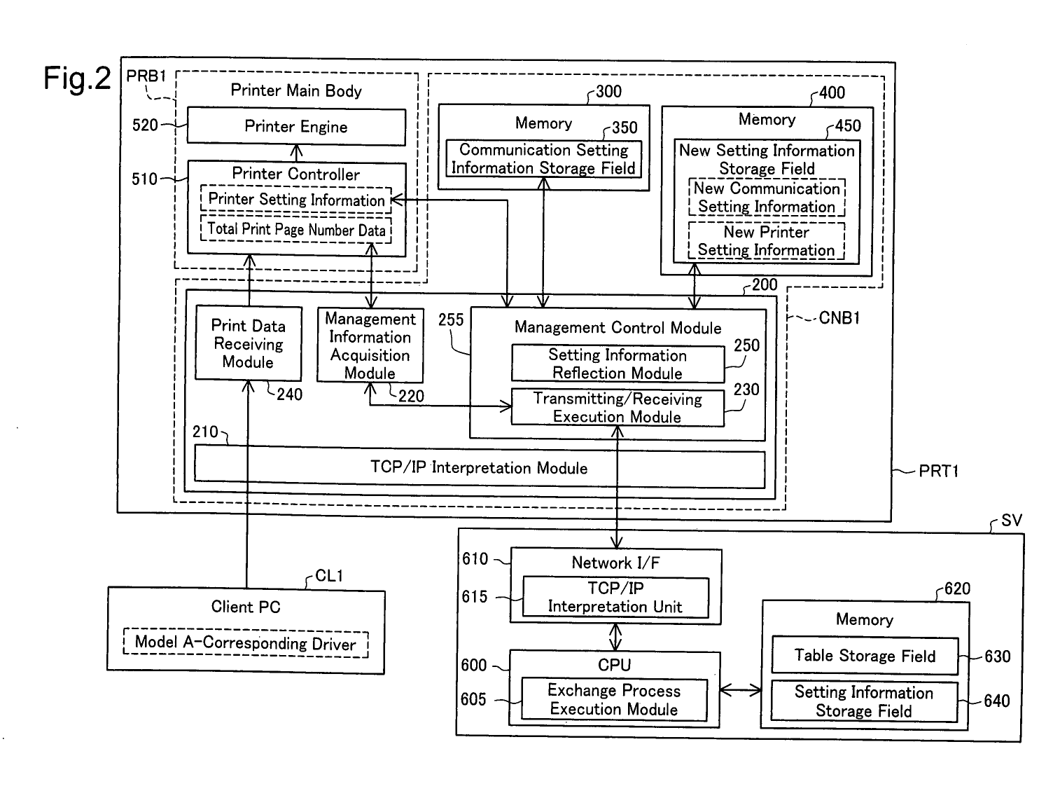

FIG. 2 shows the structure of the printer PRT and the management server SV included in the printer management system of the embodiment. The printers PRT2 to PRT5 have identical structures with the structure of the printer PRT1 and are not specifically shown in FIG. 2. The following description regards the structure of the printer PRT1 as a representative of all the printers PRT.

The printer PRT1 includes a printer main body PRB1 and the custom network board CNB1. The printer main body PRB1 has a printer engine 520 and a printer controller 510 as main components.

The printer engine 520 is a mechanism of actually performing printing operations. The printer controller 510 constructed as a computer including a CPU, a RAM, and a ROM (not shown) receives print job data from the custom network board CNB1 and controls the printer engine 520 to execute a printing operation according to the received print job data.

The printer controller 510 collects various pieces of information regarding the printer main body PRB1 as management information and stores the collected management information in a structure MIB (Management Information Base) (not shown). The MIB structure stores standard information uniformly defined for the printer main body and individual information uniquely defined by the manufacturer with regard to respective objects. The object information includes, for example, total print page number data of the printer PRT1, vacant capacity data of a waste toner box, and service life information of a photosensitive drum. Among the various pieces of the object information, the total print page number data is shown in FIG. 2.

The printer controller 510 also stores the setting information set in the printer PRT1 (hereafter referred to as printer setting information). The printer setting information includes, for example, energy-saving setting information, auto error-removal setting information, paper selection information, and a server certificate. The energy-saving setting information activates an energy-saving mode after continuance of the printer non-service state for a predetermined time period. In the occurrence of a specific error in the printer PRT1, the auto error-removal setting information judges the requirement or non-requirement for a response from the client CL to remove the specific error and tries automatic error removal under the judgment of non-requirement for the response from the client CL. When the printer PRT1 takes charge of selection of printing paper, the paper selection information is referred to for selection of printing paper. The server certificate includes a public key for verification in the case of a secure print process between the printer PRT1 and the client CL1.

The custom network board CNB1 characteristic of the invention mainly includes a CPU 200 and two memories 300 and 400. The custom network board CNB1 also has a communication interface for network communication and other relevant elements, which are omitted from the illustration for convenience of explanation.

The memory 300 has a communication setting information storage field 350 that stores information for identifying the printer PRT1 by network communication (hereafter referred to as communication setting information). The communication setting information includes, for example, an IP address, a subnet mask, and a default gateway.

The memory 400 has a new setting information storage field 450 that stores new setting information. The new setting information represents setting information (printer setting information and communication setting information) of the other exchange object printer PRT in the location of an expected exchange destination (expected transfer destination) sent from the management server SV in the printer exchange process (described later), when the self printer PRT including the memory 400 is selected as one exchange object printer in the exchange object printer selection process (described later). In the description below, the terminology ‘setting information’ includes both the printer setting information and the communication setting information.

The CPU 200 reads a specified application program from a memory (not shown) and executes the specified application program to work the functional blocks shown in FIG. 2. The respective functional blocks may be constructed by the hardware configuration.

Among these functional blocks, a TCP/IP interpretation module 210 adopts the TCP/IP protocol and establishes communication with the client CL1 and with the management server SV via the network.

A print data receiving module 240 receives communication data including a print job from the client CL1 and transfers the received print job to the printer controller 510.

A management information acquisition module 220 adopts an adequate protocol, for example, SNMP (Simple Network Management Control Protocol) and obtains the total print page number data stored in the MIP structure of the printer controller 510 at regular intervals.

A management control module 255 includes and controls a transmitting/receiving execution module 230 and a setting information reflection module 250. The management control module 255 acquires the printer setting information from the printer controller 510 and the communication setting information from the communication setting information storage field 350, in response to a request from the management server SV. The management control module 255 controls the internal transmitting/receiving execution module 230 to upload the acquired printer setting information and communication setting information as the setting information of the printer PRT1 to the management server SV. The management control module 255 also obtains the total print page number data from the printer controller 510 at regular intervals, and executes a new setting information reflection flag set-on process (described later).

In response to a command received from the management control module 255, the transmitting/receiving execution module 230 establishes connection with the management server SV and uploads preset information to the management server SV. For example, the transmitting/receiving execution module 230 uploads the total print page number data obtained by the management information acquisition module 220 to the management server SV at regular intervals. The transmitting/receiving execution module 230 uploads the setting information (communication setting information and printer setting information) acquired by the management control module 255 to the management server SV. The transmitting/receiving execution module 230 receives the setting information of the other exchange object printer PRT downloaded from the management server SV and stores the received setting information of the other exchange object printer PRT as new setting information into the new setting information storage field 450.

The setting information reflection module 250 sets on a new setting information reflection flag under a predetermined condition as described later. The setting information reflection module 250 checks the state of the new setting information reflection flag in response to a power-on operation of the printer PRT1 and acquires the new setting information stored in the new setting information storage field 450 under the ON-setting of the flag to enable reflection of the acquired new setting information.

The printers PRT2 to PRT5 are of the same model as the printer PRT1 and have the identical structures and functions with those described above.

The management server SV is constructed as a computer system including a CPU 600, a memory 620, and a network I/F 610 as shown in FIG. 2.

The CPU 600 reads a specified application program from a memory (not shown) and executes the specified application program to function as an exchange process execution module 605 characteristic of the invention as shown in FIG. 2. The exchange process execution module 605 executes the exchange object printer selection process and the printer exchange process as the characteristic of the invention to exchange the selected exchange object printers PRT connecting with the local area network LAN1.

The memory 620 includes a table storage field 630 and a setting information storage field 640. The table storage field 630 stores management information tables, which are provided for respective printer models in this embodiment as described later. The setting information storage field 640 stores the setting information of each printer PRT in relation to the IP address allocated to the printer PRT.

The network I/F 610 is a communication interface to implement network communication and includes a TCP/IP interpretation unit 615, which adopts the TCP/IP protocol to make communication with the printers PRT1 to PRT5 via the network.

The management server SV has diversity of other general computer elements, which are omitted from the illustration for convenience of explanation.

A3. Exchange Object Printer Selection Process

The exchange process execution module 605 executes the exchange object printer selection process that is characteristic of the invention as described below. The exchange object printer selection process refers to the total print page number data received from the respective printers PRT and compares the frequencies in use of the respective printers PRT. The exchange object printer selection process selects two printers PRT as exchange object printers to be exchanged, based on the result of the comparison. As the premise for this process, each printer PRT connecting with the local area network LAN1 uploads the total print page number data to the management server SV at regular intervals. In the system of this embodiment, the exchange object printer selection process and the subsequent printer exchange process are performed during regular business hours (office hours) of the organization OG. For example, when the regular business hours (office hours) of the organization OG are from 9 am to 5 pm, the exchange process execution module 605 may execute the exchange object printer selection process and the subsequent printer exchange process between 3 pm and 5 pm.

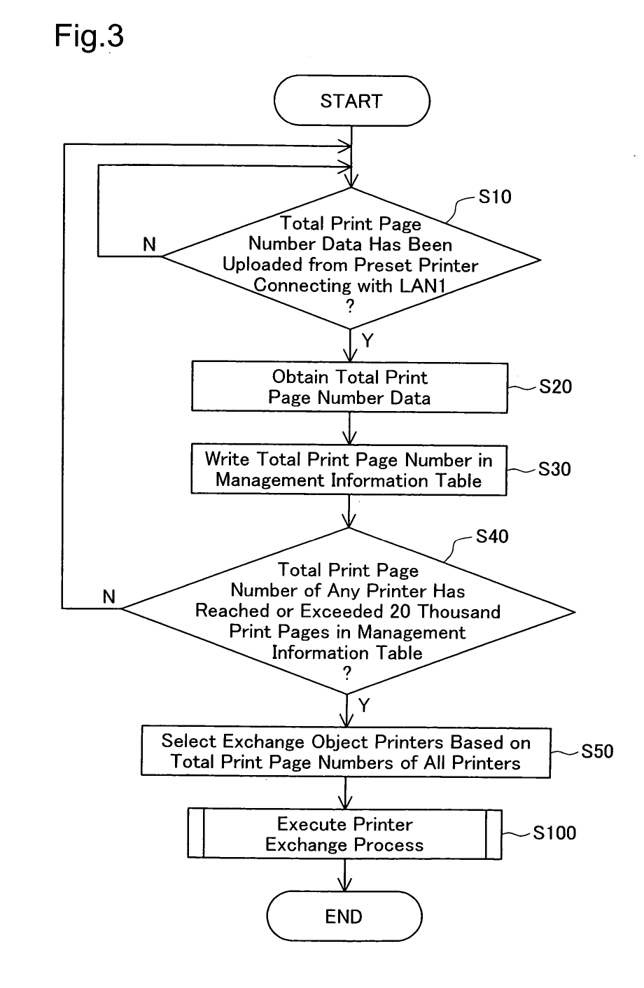

FIG. 3 is a flowchart showing the exchange object printer selection process executed in this embodiment. The exchange process execution module 605 first determines whether the total print page number data has been uploaded from a preset printer PRT connecting with the local area network LAN1 (step S10).

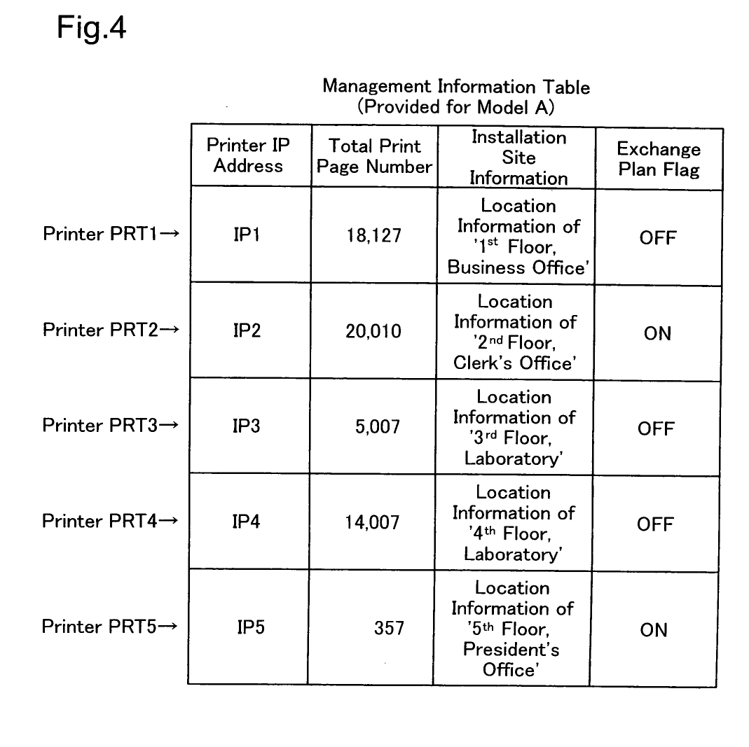

FIG. 4 shows the management information table of this embodiment. This management information table is provided for each printer model. The description regards only one management information table provided for the model A. As shown in FIG. 4, the management information table stores total print page numbers, installation site information, and settings of an exchange plan flag written in relation to the IP addresses of the respective printers PRT1 to PRT5 connecting with the local area network LAN1. The IP addresses and the installation site information of the respective printers PRT are input in advance. In the illustrated example of FIG. 4, location information of ‘1st floor, business office’ is input as the installation site information corresponding to the IP address IP1 representing the printer PRT1, and location information of ‘2nd floor, clerk's office’ as the installation site information corresponding to the IP address IP2 representing the printer PRT2. Similarly location information of ‘3rd floor, laboratory’ is input as the installation site information corresponding to the IP address IP3 representing the printer PRT3, location information of ‘4th floor, laboratory’ as the installation site information corresponding to the IP address IP4 representing the printer PRT4, and location information of ‘5th floor, president's office’ as the installation site information corresponding to the IP address IP5 representing the printer PRT5. The exchange plan flag will be described later in detail.

When the total print page number data has been uploaded from the preset printer PRT (step S10: Yes), the exchange process execution module 605 obtains the total print page number data from the preset printer PRT (step S20) and writes the total print page number shown by the obtained total print page number data in relation to the IP address of the preset printer PRT in the management information table provided for the model A (step S30). The greater total print page number naturally indicates the high frequency in use of the printer PRT. The total print page number is thus used as an index of the frequency in use of each printer PRT.

The exchange process execution module 605 determines whether the total print page number of any printer PRT written in the management information table has reached or exceeded 20 thousand print pages (step S40). When the total print page number of any printer PRT written in the management information table has not yet reached 20 thousand print pages (step S40: No), the exchange process execution module 605 goes back to the processing of step S10.

When the total print page number of any printer PRT written in the management information table has reached or exceeded 20 thousand print pages (step S40: Yes), on the other hand, it is an exchange timing when part of the printers PRT of the model A are to be exchanged. The exchange process execution module 605 thus selects exchange object printers PRT based on the total print page numbers of all the printers PRT and sets on the exchange plan flag in relation to the IP addresses of the selected exchange object printers PRT in the management information table (step S50). The concrete procedure selects the printer PRT having the total print page number of or over 20 thousand print pages (that is, the printer PRT having the greatest print page number) and the printer PRT having the smallest total print page number in the management information table, as the exchange object printers PRT. Namely the printer PRT having the highest frequency in use and the printer PRT having the lowest frequency in use are selected as the exchange object printers PRT.

The following description is on the assumption that the printer PRT2 has the greatest total print page number and the printer PRT5 has the smallest total print page number as shown in the management information table of FIG. 4. The exchange process execution module 605 accordingly selects the printers PRT2 and PRT5 as the exchange object printers PRT and sets on the exchange plan flag in relation to the IP addresses IP2 and IP5 of the selected exchange object printers PRT2 and PRT5 in the management information table. The exchange process execution module 605 executes the subsequent printer exchange process with regard to the printers PRT having the ON setting of the exchange plan flag.

A4. Printer Exchange Process

The exchange process execution module 605 subsequently executes the printer exchange process (step S100) as described below. As the premise for the printer exchange process, each printer PRT makes access to the management server SV to upload preset information including the total print page number data to the management server SV at regular intervals.

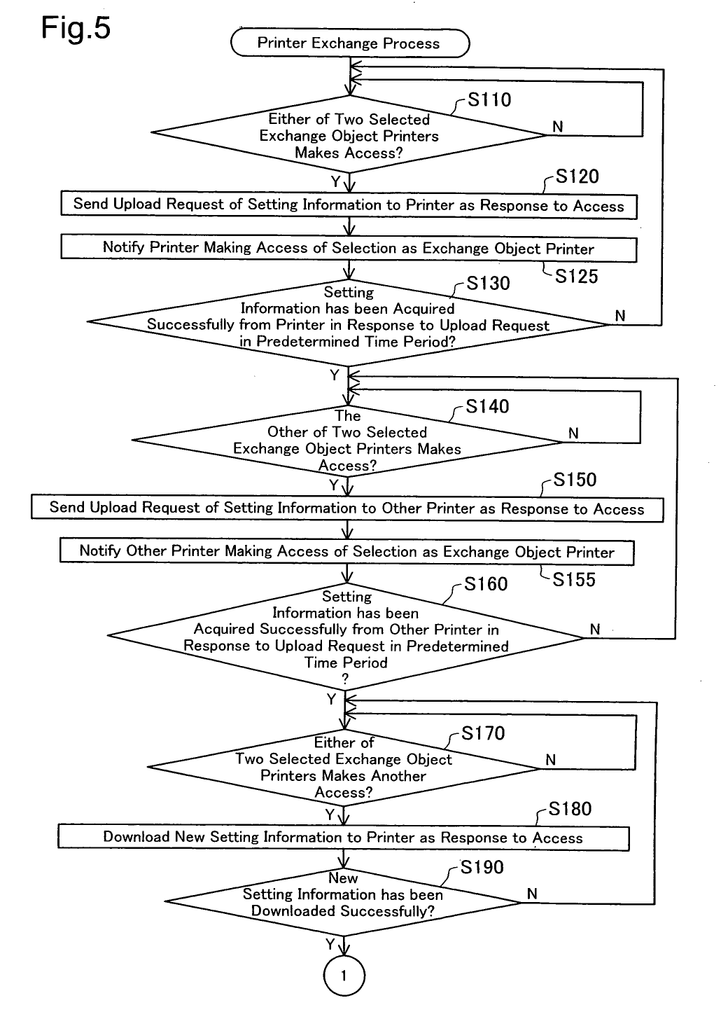

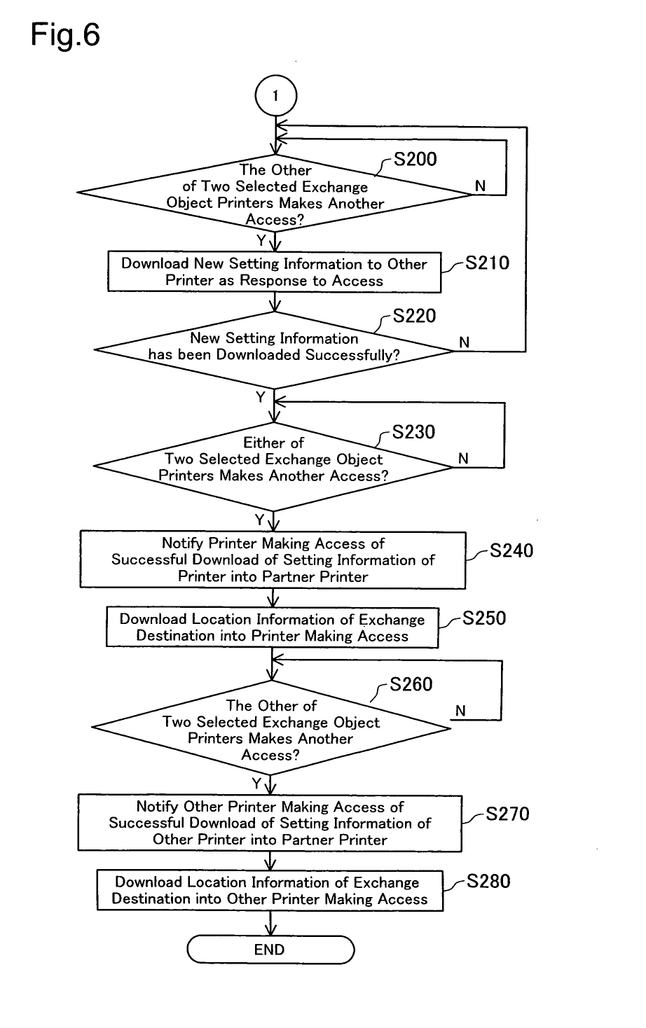

FIGS. 5 and 6 are flowcharts showing the details of the printer exchange process executed in this embodiment.

In the printer exchange process of FIG. 5, the exchange process execution module 605 first determines whether either of the two selected exchange object printers PRT (either the printer PRT2 or the printer PRT5) makes access to the management server SV (step S110). The exchange process execution module 605 waits until access (step S110: No).

When either of the two selected exchange object printers PRT makes access to the management server SV (step S110: Yes), the exchange process execution module 605 sends an upload request of the setting information as a response to the access from the selected exchange object printer PRT (step S120). In the printer PRT receiving the upload request, the management control module acquires the printer setting information from the printer controller and the communication setting information from the communication setting information storage field and controls the transmitting/receiving execution module to upload the acquired printer setting information and communication setting information as the setting information of the printer PRT to the management server SV.

The exchange process execution module 605 notifies the selected exchange object printer PRT making access of the selection of the printer PRT as one exchange object printer (step S125), simultaneously with the upload request sent at step S120.

The exchange process execution module 605 waits for a predetermined time period and determines whether the setting information has been acquired successfully from the selected exchange object printer PRT in response to the upload request in the predetermined time period (step S130). In the case of failed acquisition of the setting information in the predetermined time period (step S130: No), the exchange process execution module 605 goes back to the processing of step S110.

In the case of successful acquisition of the setting information from the selected exchange object printer PRT in response to the upload request in the predetermined time period (step S130: Yes), the exchange process execution module 605 subsequently determines whether the other of the two selected exchange object printers PRT makes access to the management server SV (step S140). For example, when the printer PRT2 has made access to the management server SV at step S110, it is determined whether the printer PRT5 makes access at step S140. The exchange process execution module 605 waits until access (step S140: No).

When the other of the two selected exchange object printers PRT makes access to the management server SV (step S140: Yes), the exchange process execution module 605 sends an upload request of the setting information as a response to the access from the other exchange object printer PRT (step S150). In the printer PRT receiving the upload request, the management control module acquires the printer setting information from the printer controller and the communication setting information from the communication setting information storage field and controls the transmitting/receiving execution module to upload the acquired printer setting information and communication setting information as the setting information of the printer PRT to the management server SV.

The exchange process execution module 605 notifies the other exchange object printer PRT making access of the selection of the printer PRT as one exchange object printer (step S155), simultaneously with the upload request sent at step S150.

The exchange process execution module 605 waits for a predetermined time period and determines whether the setting information has been acquired successfully from the other exchange object printer PRT in response to the upload request in the predetermined time period (step S160). In the case of failed acquisition of the setting information in the predetermined time period (step S160: No), the exchange process execution module 605 goes back to the processing of step S140.

In the case of successful acquisition of the setting information from the other exchange object printer PRT in response to the upload request in the predetermined time period (step S160: Yes), the exchange process execution module 605 terminates the connection. The exchange process execution module 605 again determines whether either of the two selected exchange object printers PRT (either the printer PRT2 or the printer PRT5) makes another access to the management server SV (step S170). The exchange process execution module 605 waits until another access (step S170: No).

When either of the two selected exchange object printers PRT makes another access to the management server SV (step S170: Yes), the exchange process execution module 605 responds to the access from the exchange object printer PRT and downloads the previously acquired setting information of the partner exchange object printer PRT, which is different from the exchange object printer PRT making access, as new setting information to the exchange object printer PRT making access (step S180). For example, when the printer PRT2 as one of the two selected exchange object printers PRT makes another access at step S170, the acquired setting information of the partner exchange object printer PRT5 is downloaded into the printer PRT2 at step S180. In the exchange object printer PRT making access and receiving the successfully downloaded setting information as the new setting information, the management control module stores the new setting information into the new setting information storage field. The management control module then controls the transmitting/receiving execution module to make another access to the management server SV and notifies the management server SV of the successful download. In one possible modification, in the case of successful acquisition of the setting information from the exchange object printer PRT in the predetermined time period (step S160: Yes), the exchange process execution module 605 may respond to the successful upload from the uploaded exchange object printer PRT and download the previously acquired setting information of the partner exchange object printer PRT as the new setting information into the uploaded exchange object printer PRT.

The exchange process execution module 605 then determines whether the new setting information has been downloaded successfully to the exchange object printer PRT making access (step S190). In the event of no notification of the successful download from the new setting information-downloaded exchange object printer PRT in a preset time period, the exchange process execution module 605 determines failed download of the new setting information to the exchange object printer PRT making access (step S190: No) and goes back to the processing of step S170.

In the case of notification of the successful download from the new setting information-downloaded exchange object printer PRT in the preset time period, on the other hand, the exchange process execution module 605 determines successful download of the new setting information to the exchange object printer PRT making access (step S190: Yes). In the printer exchange process of FIG. 6, the exchange process execution module 605 subsequently determines whether the other of the two selected exchange object printers PRT makes another access to the management server SV (step S200). For example, when the printer PRT2 has made another access to the management server SV at step S170, it is determined whether the printer PRT5 makes another access at step S200. The exchange process execution module 605 waits until another access (step S200: No).

When the other of the two selected exchange object printers PRT makes another access to the management server SV (step S200: Yes), the exchange process execution module 605 responds to the access from the exchange object printer PRT and downloads the previously acquired setting information of the partner exchange object printer PRT, which is different from the exchange object printer PRT making access, as new setting information to the other exchange object printer PRT making access (step S210). For example, when the printer PRT2 as one of the two selected exchange object printers PRT has made another access at step S170 and the printer PRT5 as the other of the two selected exchange object printers PRT makes another access at step S200, the acquired setting information of the partner exchange object printer PRT2 is downloaded into the printer PRT5 at step S210. In the exchange object printer PRT making access and receiving the successfully downloaded setting information as the new setting information, the management control module stores the new setting information into the new setting information storage field. The management control module then controls the transmitting/receiving execution module to make another access to the management server SV and notifies the management server SV of the successful download.

The exchange process execution module 605 then determines whether the new setting information has been downloaded successfully to the other exchange object printer PRT making access (step S220). In the event of no notification of the successful download from the new setting information-downloaded exchange object printer PRT in the preset time period, the exchange process execution module 605 determines failed download of the new setting information to the exchange object printer PRT making access (step S220: No) and goes back to the processing of step S200.

In the case of notification of the successful download from the new setting information-downloaded exchange object printer PRT in the preset time period, on the other hand, the exchange process execution module 605 determines successful download of the new setting information to the exchange object printer PRT making access (step S220: Yes) and terminates the connection. The exchange process execution module 605 again determines whether either of the two selected exchange object printers PRT (either the printer PRT2 or the printer PRT5) makes another access to the management server SV (step S230). The exchange process execution module 605 waits until another access (step S230: No).

When either of the two selected exchange object printers PRT makes another access to the management server SV (step S230: Yes), the exchange process execution module 605 responds to the access from the exchange object printer PRT and notifies the exchange object printer PRT making access of successful download of the setting information of the exchange object printer PRT into the partner exchange object printer PRT, which is different from the exchange object printer PRT making access (step S240). For example, when the printer PRT2 as one of the two selected exchange object printers PRT makes another access at step S230, the printer PRT2 is notified of the successful download of the setting information of the printer PRT2 into the partner exchange object printer PRT5 at step S240. In one possible modification, in the case of notification of the successful download from the new setting information-downloaded exchange object printer PRT in the preset time period (step S220: Yes), the exchange process execution module 605 may respond to the notification and, inform the notified exchange object printer PRT of successful download of the setting information of the notified exchange object printer PRT into the partner exchange object printer PRT.

The exchange process execution module 605 obtains the installation site information of the partner exchange object printer PRT, which is different from the exchange object printer PRT making access, from the management information table (see FIG. 4) and downloads the obtained installation site information of the partner exchange object printer PRT into the exchange object printer PRT making access (step S250), simultaneously with the notification of the successful download at step S240. For example, when the printer PRT2 as one of the two selected exchange object printers PRT makes another access at step S230, the installation site information of the printer PRT5, that is, the location information of ‘5th floor, president's office’, is obtained from the management information table and is downloaded to the printer PRT2 at step S250. This installation site information represents the transfer destination of the printer PRT2 after the printer exchange.

The exchange process execution module 605 subsequently determines whether the other of the two selected exchange object printers PRT makes another access to the management server SV (step S260). The exchange process execution module 605 waits until another access (step S260: No).

When the other of the two selected exchange object printers PRT makes another access to the management server SV (step S260: Yes), the exchange process execution module 605 responds to the access from the exchange object printer PRT and notifies the exchange object printer PRT making access of successful download of the setting information of the exchange object printer PRT into the partner exchange object printer PRT, which is different from the exchange object printer PRT making access (step S270). For example, when the printer PRT5 as the other of the two selected exchange object printers PRT makes another access at step S260, the printer PRT5 is notified of the successful download of the setting information of the printer PRT5 into the partner exchange object printer PRT2 at step S270.

The exchange process execution module 605 obtains the installation site information of the partner exchange object printer PRT, which is different from the exchange object printer PRT making access, from the management information table (see FIG. 4) and downloads the obtained installation site information of the partner exchange object printer PRT into the exchange object printer PRT making access (step S280), simultaneously with the notification of the successful download at step S270. For example, when the printer PRT5 as the other of the two selected exchange object printers PRT makes another access at step S260, the installation site information of the printer PRT2, that is, the location information of ‘2nd floor, clerk's office’, is obtained from the management information table and is downloaded to the printer PRT5 at step S280. This installation site information represents the transfer destination of the printer PRT5 after the printer exchange. The exchange process execution module 605 here terminates both the printer exchange process and the exchange object printer selection process.

In the event of failed processing in a preset time period at any of steps S110, S140, S170, S200, S230, and S260 in the printer exchange process, the exchange process execution module 605 may expect the occurrence of some trouble or failure (for example, power-off) in either of the selected exchange object printers PRT and interrupt the processing flow. In such cases, the exchange process execution module 605 informs the printer manager PM of interruption of the processing, for example, in the form of an alarm display on a display panel (not shown).

Each of the exchange object printers PRT2 and PRT5 downloads the installation site information representing the transfer destination from the management server SV and prints out the. downloaded installation site information.

Each of the selected exchange object printers PRT sets on the new setting information reflection flag as described below.

A5. New Setting Information Reflection Flag Set-on Process

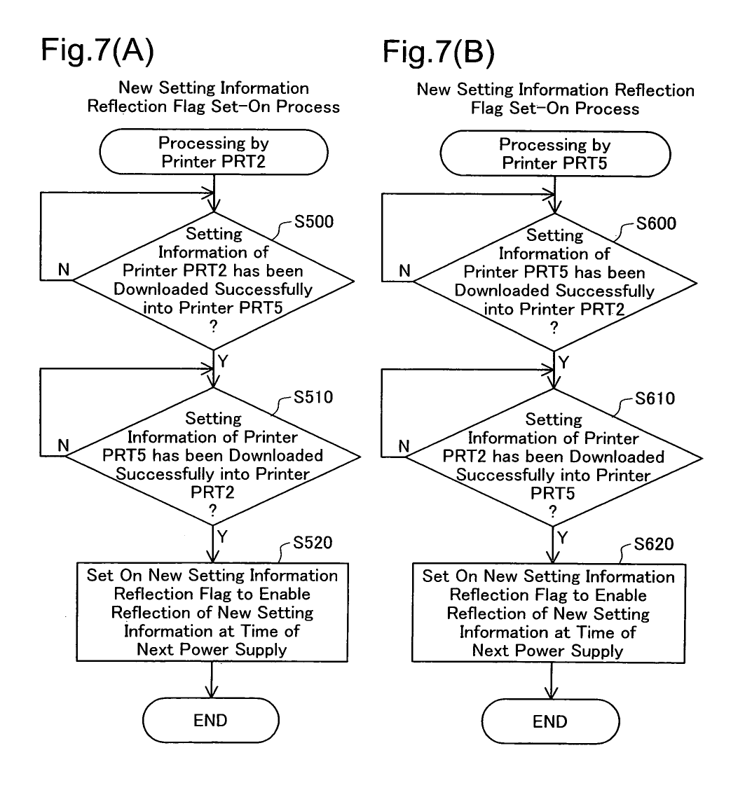

FIG. 7 is flowcharts showing the new setting information reflection flag set-on process executed by the respective exchange object printers in the embodiment. The new setting information reflection flag set-on process is triggered by an upload request of the setting information sent from the management server SV to the exchange object printer PRT in the printer exchange process, but is not synchronous with the printer exchange process. Each of the exchange object printers PRT is powered off for the exchange (transfer) after completion of the printer exchange process executed by the management server SV. The new setting information reflection flag set-on process sets on the new setting information reflection flag to enable reflection of the new setting information at the time of next power supply.

In the new setting information reflection flag set-on process of FIG. 7(A), the management control module (not shown) of the printer PRT2 as one of the exchange object printers PRT determines whether the setting information of the self printer PRT2 has been downloaded successfully to the other exchange object printer PRT5 by the management server SV (step S500).

The management control module of the printer PRT2 waits until notification of the successful download of the setting information of the printer PRT2 into the printer PRT5 by the management server SV at either step S240 or step S270 in the printer exchange process (step S500: No).

In the case of notification of the successful download of the setting information of the printer PRT2 into the printer PRT5 by the management server SV at either step S240 or step S270 in the printer exchange process, on the other hand, the management control module of the printer PRT2 determines that the setting information of the self printer PRT2 has been downloaded successfully to the printer PRT5 by the management server SV (step S500: Yes) and subsequently determines whether the setting information of the printer PRT5 has been downloaded successfully to the self printer PRT2 (step S510).

The management control module of the printer PRT2 waits in the event of failed download of the setting information of the printer PRT5 into the self printer PRT2 by the management server SV at either step S190 or step S220 in the printer exchange process (step S510: No).

In the case of successful download of the setting information of the printer PRT5 into the self printer PRT2 by the management server SV at either step S190 or step S220 in the printer exchange process (step S510: Yes), on the other hand, the management control module of the printer PRT2 sets on the new setting information reflection flag to enable reflection of the new setting information at the time of next power supply and stores the ON setting of the new setting information reflection flag into the new setting information storage field 450 (step S520). The management control module of the printer PRT2 then exits from this new setting information reflection flag set-on process.

In the new setting information reflection flag set-on process of FIG. 7(B), the management control module (not shown) of the printer PRT5 as one of the exchange object printers PRT determines whether the setting information of the self printer PRT5 has been downloaded successfully to the other exchange object printer PRT2 by the management server SV (step S600).

The management control module of the printer PRT5 waits until notification of the successful download of the setting information of the printer PRT5 into the printer PRT2 by the management server SV at either step S240 or step S270 in the printer exchange process (step S600: No).

In the case of notification of the successful download of the setting information of the printer PRT5 into the printer PRT2 by the management server SV at either step S240 or step S270 in the printer exchange process, on the other hand, the management control module of the printer PRT5 determines that the setting information of the self printer PRT5 has been downloaded successfully to the printer PRT2 by the management server SV (step S600: Yes) and subsequently determines whether the setting information of the printer PRT2 has been downloaded successfully to the self printer PRT5 (step S610).

The management control module of the printer PRT5 waits in the event of failed download of the setting information of the printer PRT2 into the self printer PRT5 by the management server SV at either step S190 or step S220 in the printer exchange process (step S610: No).

In the case of successful download of the setting information of the printer PRT2 into the self printer PRT5 by the management server SV at either step S190 or step S220 in the printer exchange process (step S610: Yes), on the other hand, the management control module of the printer PRT5 sets on the new setting information reflection flag to enable reflection of the new setting information at the time of next power supply and stores the ON setting of the new setting information reflection flag into the new setting information storage field 450 (step S620). The management control module of the printer PRT5 then exits from this new setting information reflection flag set-on process.

The new setting information reflection flag set-on process is generally completed, prior to conclusion of the printer exchange process by the management server SV. The new setting information reflection flag set-on process is performed in response to the processing of either step S190 or step S220 in the printer exchange process. The new setting information reflection flag is accordingly set on, before each of the exchange object printers PRT2 and PRT5 prints out the installation site information of the exchange destination (transfer destination), which is downloaded at either step S250 or S280 in the printer exchange process by the management server SV. After the business hours of the organization OG, these printers PRT are powered off. A dispatched worker from the printer manager PM transfers each of the exchange object printers PRT, based on the installation site information printed out by the exchange object printer PRT.

For example, the printer PRT2 prints out the installation site information of the printer PRT5 (the location information of ‘5th floor, president's office’) on completion of the printer exchange process by the management server SV. The dispatched worker transfers the powered-off printer PRT2 to the location ‘5th floor, president's office’ indicated by the printed-out installation site information and replaces the printer PRT5 with the transferred printer PRT2. Similarly the printer PRT5 prints out the installation site information of the printer PRT2 (the location information of ‘2nd floor, clerk's office’) on completion of the printer exchange process by the management server SV. The dispatched worker transfers the powered-off printer PRT5 to the location ‘2nd floor, clerk's office’ indicated by the printed-out installation site information and replaces the printer PRT2 with the transferred printer PRT5.

Each of the exchange object printers PRT transferred by the dispatched worker is powered on, for example, on the next day. In response to the ON setting of the new setting information reflection flag stored in the new setting information storage field, the management control module of each exchange object printer PRT reads the new setting information, which represents the setting information of the other exchange object printer PRT located in the exchange destination, from the new setting information storage field and enables the new setting information to be reflected in place of the original setting information. The management control module of each exchange object printer PRT reads the new setting information from the new setting information storage field. The management control module then replaces the new communication setting information included in the new setting information for the original communication setting information stored in the communication setting information storage field, while replacing the new printer setting information included in the new setting information for the original printer setting information stored in the printer controller.

For example, the management control module of the printer PRT2 reads the new setting information (that is, the setting information including the communication setting information and the printer setting information of the printer PRT5) from the storage of the new setting information storage field (not shown). The management control module of the printer PRT2 then replaces the new communication setting information included in the new setting information for the original communication setting information stored in the communication setting information storage module, while replacing the new printer setting information included in the new setting information for the original printer setting information stored in the printer controller.

A6. Effects of Embodiment

The printer management system 1000 of this embodiment refers to the total print page numbers of the respective printers PRT as the index of the frequencies in use of the printers PRT. When the total print page number of any printer PRT reaches or exceeds 20 thousand print pages, the printer PRT having the total print page number of or over 20 thousand print pages and the printer PRT having the smallest total print page number are selected as the exchange object printers. The locations of the two selected exchange object printers PRT are then exchanged. The frequencies in use of the printers PRT in the respective installation sites are expected to be not significantly changed with time. The location exchange thus desirably equalizes the use frequencies of the respective printers PRT and reduces the demand for replacement of preset long-term parts, for example, a waste toner box and a photosensitive drum, in the respective printers PRT. The technique of this embodiment does not exchange the corresponding long-term parts between multiple printers but requires only the simple location exchange of the selected printers PRT to reduce the demand for replacement of the long-term parts in the respective printers PRT.

In the printer management system 1000 of the embodiment, each of the selected exchange object printers PRT acquires the setting information (communication setting information and printer setting information) of the printer PRT located in the exchange destination (transfer destination) and enables the acquired setting information to be reflected after the location exchange. The printers PRT2 and PRT5 are of the same model and correspond to the same printer driver installed in the respective clients CL, as described above. The technique of this embodiment simply exchanges the locations of the printers PRT2 and PRT5 selected as the exchange object printers PRT without requiring any change of the PC settings in the respective clients CL. The location exchange of the selected exchange object printers PRT does not change the location of the printer PRT used for printing by each client CL, thus not sacrificing the convenience of each user operating the client CL.

In the printer management system 1000 of the embodiment, each of the selected exchange object printers PRT sets on the new setting information reflection flag when the new setting information as the setting information of the self printer PRT has been downloaded successfully into the other exchange object printer PRT and the new setting information as the setting information of the other exchange object printer PRT has been downloaded successfully into the self printer PRT. The dispatched worker exchanges the locations of the selected exchange object printers PRT and subsequently enables the new setting information to be reflected in the respective location-exchanged printers PRT under the ON setting of the new setting information reflection flag. The location exchange and subsequent reflection desirably prevents the new setting information from being reflected only in one of the location-exchanged printers PRT and restrains the duplicated setting of the same communication setting information (for example, the IP address) in multiple printers. This arrangement effectively avoids potential troubles and failures in network communication due to the duplicated setting of the identical communication setting information.

In the printer management system 1000 of the embodiment, each of the exchange object printers PRT2 and PRT5 prints out the location information of the transfer destination downloaded by the management server SV (at either step S250 or step S280 in the printer exchange process). The print-out enables the dispatched worker to readily check the exchange destination (transfer destination).

### B. MODIFICATIONS

The embodiment discussed above is to be considered in all aspects as illustrative and not restrictive. There may be many modifications, changes, and alterations without departing from the scope or spirit of the main characteristics of the present invention.

### B1. Modified Example 1

In the exchange object printer selection process of the embodiment, the exchange process execution module 605 selects the exchange object printers PRT among the printers of the same model. This arrangement is, however, only illustrative and not restrictive in any sense. In one possible modification, the exchange process execution module 605 may select the exchange object printers PRT among printers of various models supported by the printer drivers installed in the client CL. In another possible modification, the exchange process execution module 605 may select the exchange object printers PRT among the printers of various models that are allowed to print without the printer driver installed in the client CL and to receive a print job in a common print format. The printers that are allowed to receive a print job in a common print format include, for example, printers that adopt the IPP protocol (Internet Printing Protocol) for printing and printers that adopt the PostScript language for printing. In either of these modified arrangements, even after the location exchange of the selected exchange object printers PRT, each user is allowed to use the location-exchanged printer PRT adequately for printing without changing the PC setting in the client CL.

### B2. Modified Example 2

In the system of the embodiment, the reflection timing of the new setting information in each selected exchange object printer PRT is the time of next power supply of the printer PRT under the ON setting of the new setting information reflection flag. This arrangement is, however, only illustrative and not restrictive in any sense. Any other arrangement may be adopted as long as the new setting information is reflected simultaneously in both the selected exchange object printers PRT. For example, the management control module of the printer PRT may enable reflection of the new setting information at a preset time. The dispatched worker may manipulate an operation panel (not shown) provided on each of the selected exchange object printers PRT to enable reflection of the new setting information. Reflection of the new setting information may otherwise be enabled at the time of next power supply after a preset time or in response to an instruction from the management server SV after the location exchange of the selected printers PRT.

### B3. Modified Example 3

In the exchange object printer selection process (see FIG. 3) of the embodiment, the exchange process execution module 605 selects the exchange object printers PRT when the total print page number of any printer PRT reaches or exceeds 20 thousand print pages. The technique of the invention is, however, not restricted to this arrangement. In one possible modification, the exchange process execution module 605 may select the exchange object printers PRT at every preset time interval. After elapse of every preset time interval, the exchange process execution module 605 specifies the printer PRT having the greatest total print page number and the printer PRT having the smallest total print page number as the exchange object printers PRT. In another possible modification, the exchange process execution module 605 may compute an increase of the total print page number since a predetermined reference time and select the exchange object printers PRT when the computed increase of the total print page number reaches or exceeds a specific print page number. When the increase of the total print page number of any printer PRT reaches or exceeds the specific print page number, the exchange process execution module 605 selects the printer PRT having the greatest increase of the total print page number and the printer PRT having the smallest increase of the total print page number as the exchange object printers PRT. These modified arrangements can accurately specify the printer PRT having the highest use frequency and the printer PRT having the lowest use frequency as the exchange object printers PRT and thereby efficiently equalize the use frequencies of the respective printers PRT.

### B4. Modified Example 4

In the exchange object printer selection process of the embodiment, the exchange process execution module 605 selects the exchange object printers PRT when the total print page number of any printer PRT reaches or exceeds 20 thousand print pages at step S40. The technique of the invention is, however, not restricted to this arrangement. For example, the exchange process execution module 605 may select the exchange object printers PRT based on another reference value of the total print page number, for example, 60 thousand print pages.

### B5. Modified Example 5

In the exchange object printer selection process of the embodiment, the exchange process execution module 605 selects the printer PRT having the highest use frequency and the printer PRT having the lowest use frequency as the two exchange object printers PRT. The technique of the invention is, however, not restricted to this arrangement. The exchange process execution module 605 may select three or more exchange object printers PRT. In one possible modification, the exchange process execution module 605 may select the printers PRT having the use frequencies in an upper 20% range and the printers PRT having the use frequencies in a lower 20% range as the exchange object printers PRT. The printer PRT having the highest use frequency is to be exchanged with the printer PRT having the lowest use frequency. The printer PRT having the second highest use frequency is to be exchanged with the printer PRT having the second lowest use frequency. In this manner, the printer PRT having an n-th highest use frequency is to be exchanged with the printer PRT having an n-th lowest use frequency (where n is an integer of not less than 3). In the illustrated example of FIG. 4, the exchange process execution module 605 selects the printers PRT2 and PRT1 having the use frequencies in the upper 20% range and the printers PRT5 and PRT3 having the use frequencies in the lower 20% range, as the exchange object printers PRT. The printer PRT2 is to be exchanged with the printer PRT5, and the printer PRT1 is to be exchanged with the printer PRT3. The locations of the exchange object printers PRT are to be exchanged in each pair in the subsequent printer exchange process. This modified arrangement efficiently equalizes the use frequencies of the respective printers PRT and thus effectively reduces the demand for replacement of preset long-term parts, for example, a waste toner box and a photosensitive drum, in the respective printers PRT.

In the case where three or more printers PRT are selected as the exchange object printers, the exchange process execution module 605 may replace the locations of the three exchange object printers PRT in a circle, in place of the location exchange of the two exchange object printers PRT in pair. For example, the three exchange object printers PRT are expressed as printers XX, YY, and ZZ. The exchange process execution module 605 obtains the setting information from each of the three selected exchange object printers PRT (printers XX, YY, and ZZ). The exchange process execution module 605 then downloads the obtained setting information of the printer XX into the printer YY, the obtained setting information of the printer YY into the printer ZZ, and the obtained setting information of the printer ZZ into the printer XX in a circle. After confirmation of the successful download into the respective printers, the exchange process execution module 605 notifies the printer XX of the successful download of the setting information of the printer XX into the printer YY and simultaneously downloads the installation site information of the exchange destination to the printer XX. Similarly the exchange process execution module 605 notifies the printer YY or the printer ZZ of the successful download of the setting information of the printer YY or of the printer ZZ into the printer ZZ or into the printer XX and simultaneously downloads the installation site information of the exchange destination to the printer YY or to the printer ZZ. Each of the three exchange object printers PRT (printers XX, YY, and ZZ) prints out the installation site information of the exchange destination. The dispatched worker replaces the locations of the three exchange object printers PRT in a circle, based on the print-outs. After the location replacement by the dispatched worker, each of the three exchange object printers PRT (printers XX, YY, and ZZ) enables reflection of the new setting information. The frequencies in use of the printers PRT in the respective installation sites are expected to be not significantly changed with time. The location replacement thus desirably equalizes the use frequencies of the respective printers PRT and effectively reduces the demand for replacement of preset long-term parts, for example, a waste toner box and a photosensitive drum, in the respective printers PRT.

### B6. Modified Example 6

In the system of the embodiment, a fixed IP address is allocated to each printer PRT linked to the local area network LAN1. The technique of the invention is, however, not restricted to this arrangement. A dynamic IP address may be allocated to each printer PRT by a DHCP (Dynamic Host Configuration Protocol) server. For identification of the printer PRT as the printing destination, the client CL is required to acquire the IP address dynamically allocated to the printer PRT of the printing destination. The client CL can, however, identify the printer PRT of the printing destination by a logic printer name, such as SMP or AppleTalk, without acquiring the dynamic IP address. In this modified arrangement, the logic printer names of the selected exchange object printers PRT are exchanged in the printer exchange process. After exchange of the locations of the respective exchange object printers PRT, the exchanged logic printer names are reflected in the respective location-exchanged printers PRT. The user of the client CL using one of the location-exchanged printers PRT can thus use the newly-located exchange object printer PRT for printing without any difficulties.

### B7. Modified Example 7

In the system of the embodiment, the management server SV manages the total print page number data and the installation site information of each printer PRT in relation to the IP address of the printer PRT in the management information table. This arrangement is, however, only illustrative and not restrictive in any sense. In one possible modification, the management control module of each printer PRT reads production number data from the printer controller, creates an inherent ID for identifying the printer PRT (printer ID) based on the production number data, and uploads the printer ID to the management server SV. The management server SV may manage the total print page number data and the installation site information of each printer PRT in relation to the printer ID. In this modified structure, each printer PRT uploads the total print page number data and the installation site information in relation to the printer ID to the management server SV. The management server SV can accurately manage the information of each printer PRT in relation to the printer ID even when a dynamic IP address is allocated to each printer PRT.

As long as the unique printer ID is obtainable, the management control module of each printer PRT may use any information other than the production number data for creation of the printer ID. For example, the management control module of each printer PRT may create the printer ID from a MAC address of the custom network board CNB or from a USB ID in the presence of a USB in the printer PRT.

### B8. Modified Example 8

In the system of the embodiment, the software configurations and the hardware configurations of the printers PRT and the management server SV may be actualized respectively by the hardware configurations and the software configurations.

### B9. Modified Example 9

In the exchange object printer selection process of the embodiment, the exchange process execution module 605 selects the exchange object printers PRT, based on the total print page numbers of the respective printers PRT as the index of frequencies in use of the printers PRT. The technique of the invention is, however, not restricted to this arrangement. In one possible modification, the exchange process execution module 605 may select the exchange object printers PRT, based on service life information of a preset long-term part, for example, remaining quantity information of a waste toner box or remaining service life information of a photosensitive drum. In this modified structure, each printer PRT obtains the remaining quantity information of the waste toner box or the remaining service life information of the photosensitive drum from an MIB structure stored in the printer controller and uploads the obtained remaining quantity information or remaining service life information to the management server SV at regular intervals. This modified arrangement desirably equalizes the use frequencies of the preset long-term part in the respective printers PRT and efficiently reduces the demand for replacement of the preset long-term part in the respective printers PRT.

In another possible modification, the exchange process execution module 605 may select the exchange object printers PRT, based on service life information of a preset short-term part, which is to be replaced at relatively short time intervals, for example, toner consumption information, instead of the service life information of the long-term part. In this modified structure, each printer PRT obtains the toner consumption information from an MIB structure stored in the printer controller and uploads the obtained toner consumption information to the management server SV at regular intervals. For example, the exchange process execution module 605 may calculate an increase in toner consumption for a preset time period since a predetermined reference time in each printer PRT and select the printer PRT having the greatest increase in toner consumption and the printer PRT having the smallest increase in toner consumption as the exchange object printers PRT. This modified arrangement desirably equalizes the use frequencies of the preset short-term part in the respective printers PRT and efficiently reduces the demand for replacement of the preset short-term part in the respective printers PRT.

### B10. Modified Example 10

In the system of the embodiment, the user of the client CL that is connected with and uses one of the location-exchanged printers may be informed of the location exchange of the printers. The client CL sends each print job with the machine name of the client CL (hereafter referred to as ‘CL machine name’) used for creation of the print job and the user's name (authenticated at log-in to the client CL) of a print command to the printer PRT used for printing. The printer PRT correlates the received CL machine name and the received user's name to self printer identification information (for example, the printer name) and uploads the CL machine name and the user's name in relation to the printer name to the management server SV. The management server SV creates a management table storing the received CL machine name and the received user's name in relation to the printer name of the sender. The management server SV refers to the management table and identifies the user (the client CL) and the printer occupied by the user. On the occasion of the location exchange of selected printers, the management server SV informs the user of each location-exchanged printer of the fact of location exchange according to the following procedure. The management server SV first reads the name of each location-exchanged printer from the management table and identifies the user's name in relation to the printer name. The management server SV also reads a mail address of the identified user from a users' mail address table provided separately and sends an e-mail message telling location exchange of the printers to the identified user. The e-mail message is, for example, ‘The printer you use has been exchanged in location with the printer in the 1st floor, business office’. The user is thus informed of the fact of location exchange of the printers.

### B11. Modified Example 11

In the system of the embodiment, each of the selected exchange object printers PRT (for example, the printers PRT2 and PRT5) prints out the location information of the transfer destination downloaded from the management server SV (at either step S250 or step S280 in the printer exchange process). This arrangement is, however, only illustrative and not restrictive in any sense. In one possible modification, each of the selected exchange object printers PRT may display the location information of the transfer destination downloaded from the management server SV on a display panel (not shown) of the printer PRT. Such display ensures the similar effects to those of the print-out.

### B12. Modified Example 12

In the printer exchange process of the embodiment, each printer PRT uploads all pieces of the printer setting information to the management server SV in response to an upload request of the setting information sent from the exchange process execution module 605. This arrangement is, however, only illustrative and not restrictive in any sense. In one possible modification, in response to an upload request of the setting information sent from the exchange process execution module 605, each printer PRT may select pieces of the printer setting information, which have been changed from the default settings, and upload only the selected pieces of the printer setting information to the management server SV. This modified arrangement desirably reduces the data volume of the setting information transmitted between each printer PRT and the management server SV to relieve the network traffic congestion, while ensuring the similar effects of the embodiment.

What is claimed is:

1. A printer management system where multiple printers are linked via a network to a management server, which performs exchange of setting information inherent to each of the multiple printers,
each of the multiple printers comprising:
a transmitting/receiving execution module that sends management information representing at least part of a service status of the printer to the management server,
the management server comprising:
an exchange process execution module that acquires the management information sent from the each printer and selects at least two exchange object printers to exchange their pieces of the setting information among the multiple printers, based on the acquired management information.

2. The printer management system in accordance with claim 1,
each of the multiple printers further comprising a setting information reflection module,
wherein the exchange process execution module of the management server sends the setting information of each exchange object printer as new setting information to each partner exchange object printer,
the transmitting/receiving execution module of each exchange object printer acquires the new setting information sent from the management server, and
the setting information reflection module of the each exchange object printer enables reflection of the acquired new setting information, in place of the setting information originally set in the each exchange object printer, at a preset timing.

3. The printer management system in accordance with claim 2, wherein the exchange process execution module of the management server sends a transmission request of the setting information to each exchange object printer,
the transmitting/receiving execution module of the each exchange object printer receives the transmission request from the management server and sends back the setting information to the management server, and
the exchange process execution module of the management server acquires the setting information sent back from the each exchange object printer.

4. The printer management system in accordance with claim 1, wherein the setting information includes at least communication information for identifying each exchange object printer on the network.

5. The printer management system in accordance with claim 2, wherein in response to successful reception of the new setting information, the transmitting/receiving execution module of each exchange object printer notifies the management server of successful reception,
the exchange process execution module of the management server is notified of successful reception of the new setting information by each exchange object printer,
in response to the notification of successful reception, the exchange process execution module notifies each exchange object printer of successful transmission of the setting information of the each exchange object printer to each partner exchange object printer,
the transmitting/receiving execution module of each exchange object printer is notified of successful transmission of the setting information of the each exchange object printer to each partner exchange object printer by the management server, and
in response to the notification of successful transmission, the setting information reflection module of the each exchange object printer enables reflection of the acquired new setting information, in place of the setting information originally set in the each exchange object printer, at the preset timing.

6. The printer management system in accordance with claim 1, wherein the exchange process execution module of the management server sends location information representing a location of each exchange object printer to each partner exchange object printer and makes the each partner exchange object printer output the location information.

7. The printer management system in accordance with claim 1, wherein the multiple printers are supported by an identical printer driver.

8. A management server that is linked with multiple printers via a network and performs exchange of setting information inherent to each of the multiple printers,
the management server comprising:
an exchange process execution module that acquires management information, which represents at least part of a service status of each printer and is sent from the each printer, and selects at least two exchange object printers to exchange their pieces of the setting information among the multiple printers, based on the acquired management information.

9. The management server in accordance with claim 8, wherein the exchange process execution module sends the setting information of each exchange object printer as new setting information to each partner exchange object printer.

10. The management server in accordance with claim 9, wherein the exchange process execution module sends a transmission request of the setting information to each exchange object printer, and acquires the setting information sent back from the each exchange object printer.

11. The management server in accordance with claim 8, wherein the setting information includes at least communication information for identifying each exchange object printer on the network.

12. The management server in accordance with claim 9, wherein the exchange process execution module is notified of successful reception of the new setting information by each exchange object printer, and
in response to the notification of successful reception, the exchange process execution module notifies each exchange object printer of successful transmission of the setting information of the each exchange object printer to each partner exchange object printer.

13. The management server in accordance with claim 8, wherein the exchange process execution module sends location information representing a location of each exchange object printer to each partner exchange object printer and makes the each partner exchange object printer output the location information.

14. A printer that is linked via a network to a management server, which performs exchange of setting information inherent to each of multiple printers,
the printer sending management information representing at least part of a service status of the printer to the management server,
the printer being specified as one of at least two exchange object printers to exchange the setting information with a partner exchange object printer, based on the transmitted management information,
the printer comprising:
a transmitting/receiving execution module that acquires setting information of the partner exchange object printer from the management server; and
a setting information reflection module that enables reflection of the acquired setting information of the partner exchange object printer, in place of the setting information originally set in the printer, at a preset timing.

15. The printer in accordance with claim 14, the printer further comprising:
an output module that outputs specified information,
wherein the transmitting/receiving module acquires location information representing a location of the partner exchange object printer from the management server, and
the output module outputs the acquired location information.

16. A printer management method that performs exchange of setting information inherent to each of multiple printers via a network,
the printer management method comprising the steps of:
(a) acquiring management information that represents at least part of a service status of each of the multiple printers; and
(b) selecting at least two exchange object printers to exchange their pieces of the setting information among the multiple printers, based on the acquired management information.

17. A computer program product that is used to perform exchange of setting information inherent to each of multiple printers via a network,
the computer program product comprising:
a first program code of acquiring management information that represents at least part of a service status of each of the multiple printers;
a second program code of selecting at least two exchange object printers to exchange their pieces of the setting information among the multiple printers, based on the acquired management information; and
a computer readable medium that stores the first program code and the second program code.
